(19) United States
(12) Patent Application Publication
(10) Pub. No.: US 2007/0165996 A1
(43) Pub. Date: Jul. 19, 2007

(54) ELECTRONIC APPARATUS

(75) Inventors: Shigekazu INABA, Aichi (JP); Shingo Mouri, Aichi (JP); Michio Yokoyama, Gifu (JP); Kazunobu Iwata, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/565,997

(22) Filed: Dec. 1, 2006

(30) Foreign Application Priority Data
Dec. 26, 2005 (JP) 2005-373036

(51) Int. Cl. H04N 9/79; H04N 5/225; H04N 5/76

(52) U.S. Cl. 386/38

(57) ABSTRACT

An electronic apparatus is provided. The electronic apparatus includes an apparatus body having on one surface thereof a recording medium insertion slot of a recording medium storing portion where an information recording medium is detachably stored, in which the recording medium storing portion is obliquely provided such that the information recording medium is obliquely stored with respect to the one surface of the apparatus body.

### CROSS REFERENCES TO RELATED APPLICATIONS

The present invention contains subject matter related to Japanese Patent Application JP 2005-373036 filed in the Japanese Patent Office on Dec. 26, 2005, the entire contents of which being incorporated herein by reference.

### BACKGROUND OF THE INVENTION

1. Field of the Invention

The present invention relates to an electronic apparatus such as a digital video camera, digital still camera and electronic book player. Particularly, the present invention relates to an electronic apparatus capable of recording and/or reproducing information signals using an information recording medium.

2. Description of the Related Art

Japanese Unexamined Patent Application Publication No. 2000-322518 discloses an electronic apparatus of this kind in related art, for example. In this patent reference, there is described an electronic apparatus having an opening and closing door to open and close a recording medium insertion slot where an information recording medium such as a memory card is inserted. The electronic apparatus includes an apparatus body provided with a recording medium insertion slot from which an information recording medium is inserted and removed, and the opening and closing door turnably supported by the apparatus body in order to open and close the recording medium insertion slot. In this electronic apparatus, the opening and closing door is attached such that a straight line connecting the center of turning movement of the opening and closing door to a contact portion in contact with the apparatus body is inclined against an opening surface of the recording medium insertion slot.

According to the electronic apparatus having such structure as described in the above patent reference, in the case where an outer edge of the recording medium insertion slot is bent inward by external force, the opening and closing door may be turned backward by force given from a contacting surface to the opening and closing door, thereby preventing the opening and closing door from being broken (see paragraph [0068] of the specification).

Japanese Unexamined Patent Application Publication No. 2001-53994 discloses another electronic apparatus of this kind in related art. In this patent reference, there is described a video camera with a card type recording apparatus being incorporated, where still image data and the like among captured images are recorded in and reproduced from a card type recording medium. The video camera described in this patent reference includes an imaging portion, a viewfinder portion, a mechanical deck portion, and an opening and closing type monitor portion. The viewfinder portion is disposed at the rear of the imaging portion. The mechanical deck portion is disposed at a lower part of the imaging portion and viewfinder portion, in which captured images and the like are recorded on and reproduced from a main recording medium such as a tape-shaped recording medium or a disk-shaped recording medium. The opening and closing type monitor portion is disposed at one side of the mechanical deck portion. In this video camera, the card type recording apparatus, in which the captured images and the like are recorded on and reproduced from the card type recording medium, is disposed approximately parallel with the mechanical deck portion and monitor portion in a space provided at the lower part of the imaging portion and viewfinder portion and surrounded with the mechanical deck portion and monitor portion.

According to the video camera having such configuration, a projecting portion of the mechanical deck portion on the side opposite to the monitor portion, which has been necessary to store a card type recording-reproducing apparatus such as a memory card, can be removed. In addition, the width of a video camera can be reduced if a large aperture lens is mounted correspondingly to an increased number of pixels in a solid-state imaging device of an imager portion. Accordingly, a thin and highly sensitive video camera can be obtained (see paragraph [0037]).

However, in both the cases of the electronic apparatus described in the first patent reference and of the video camera described in the second patent reference, the recording medium insertion slot of a recording medium storing portion to store the information recording medium is provided on one surface of the apparatus body. In addition, the recording medium storing portion continuing from the recording medium insertion slot extends vertically with respect to that surface of the apparatus body.

Hereupon, the mechanical deck portion in which information signals are recorded on and reproduced from the main recording medium; a control circuit in which an LSI, resistance, and other electronic components are mounted on a circuit substrate to perform control on the recording and reproduction; and the like are incorporated in the apparatus body. If a second external memory unit is added to the above structure, the mechanical deck portion, the control circuit and the like need to be arranged such that the recording medium insertion slot is provided on one surface of the apparatus body and a space is generated for the recording medium storing portion extending in the vertical direction from that surface. As a result, with considerable restriction in the arrangement of devices and mechanisms stored inside the apparatus body, it is difficult to obtain the apparatus body small-sized and thin.

### SUMMARY OF THE INVENTION

In the past, an electronic apparatus was configured to have a recording medium storing portion extending vertically with respect to one surface of an apparatus body in which a recording medium insertion slot was provided. Therefore, the arrangement of devices and mechanisms stored inside the apparatus body was considerably restrained, and it was difficult to obtain the small-sized and thin apparatus body.

An electronic apparatus according to an embodiment of the present invention includes an apparatus body having on one surface thereof a recording medium insertion slot of a recording medium storing portion where an information recording medium is detachably stored, and the recording medium storing portion is provided obliquely so that the information recording medium is stored obliquely with respect to the surface of the apparatus body.

The electronic apparatus according to the embodiment of the present invention is configured to have the recording medium storing portion obliquely provided so that the information recording medium is stored obliquely with respect to one surface of the apparatus body where the recording medium insertion slot is provided. Therefore, a space generated inside the apparatus body can be used efficiently, thereby obtaining a small-sized and slim electronic apparatus.

### BRIEF DESCRIPTION OF THE DRAWINGS

FIG. 1 is a perspective view showing a digital video camera viewed from a front side, which is an example of an electronic apparatus according to an embodiment of the present invention;

FIG. 2 is a perspective view showing a digital video camera viewed from a rear side, which is an example of an electronic apparatus according to an embodiment of the present invention;

FIG. 3 is a front view of the digital video camera shown in FIG. 1;

FIG. 4 is a rear view of the digital video camera shown in FIG. 1;

FIG. 5 is a left side view of the digital video camera shown in FIG. 1;

FIG. 6 is a right side view of the digital video camera shown in FIG. 1;

FIG. 7 is a plan view of the digital video camera shown in FIG. 1;

FIG. 8 is a bottom view of the digital video camera shown in FIG. 1;

FIG. 9 is a perspective view with a display unit of the digital video camera shown in FIG. 1 being open and viewed from a lateral direction;

FIG. 10 is an explanatory diagram showing in an enlarged manner a recording medium insertion slot of the digital video camera shown in FIG. 1;

FIG. 11 is an explanatory diagram showing a state of a recording medium storing portion installed, with the digital video camera shown in FIG. 1 shown in cross-section in the horizontal direction;

FIG. 12 is an explanatory diagram showing a state of a recording medium storing portion installed in the digital video camera shown in FIG. 1 when the inside of an external case 2 is viewed from the outside;

FIG. 13 is an explanatory diagram showing a face cover and a part of an external case to which the face cover is attached according to the digital video camera shown in FIG. 1;

FIG. 14 is a perspective view when the face cover shown in FIG. 12 is viewed from a rear side;

FIG. 15 is an explanatory diagram showing in an enlarged manner a part of the external case with which the face cover shown in FIG. 12 is engaged; and

FIG. 16 is an explanatory diagram showing a state of the face cover being engaged with a part of the external case.

### DESCRIPTION OF THE PREFERRED EMBODIMENTS

An electronic apparatus having such advantages as described below can be obtained with a simplified structure. Specifically, a recording medium storing portion can be disposed in the electronic apparatus by efficiently using a space generated inside the apparatus body. Therefore, other components, mechanisms and the like than the recording medium storing portion can be disposed inside the apparatus body with less restriction and the whole apparatus can be small-sized and thin.

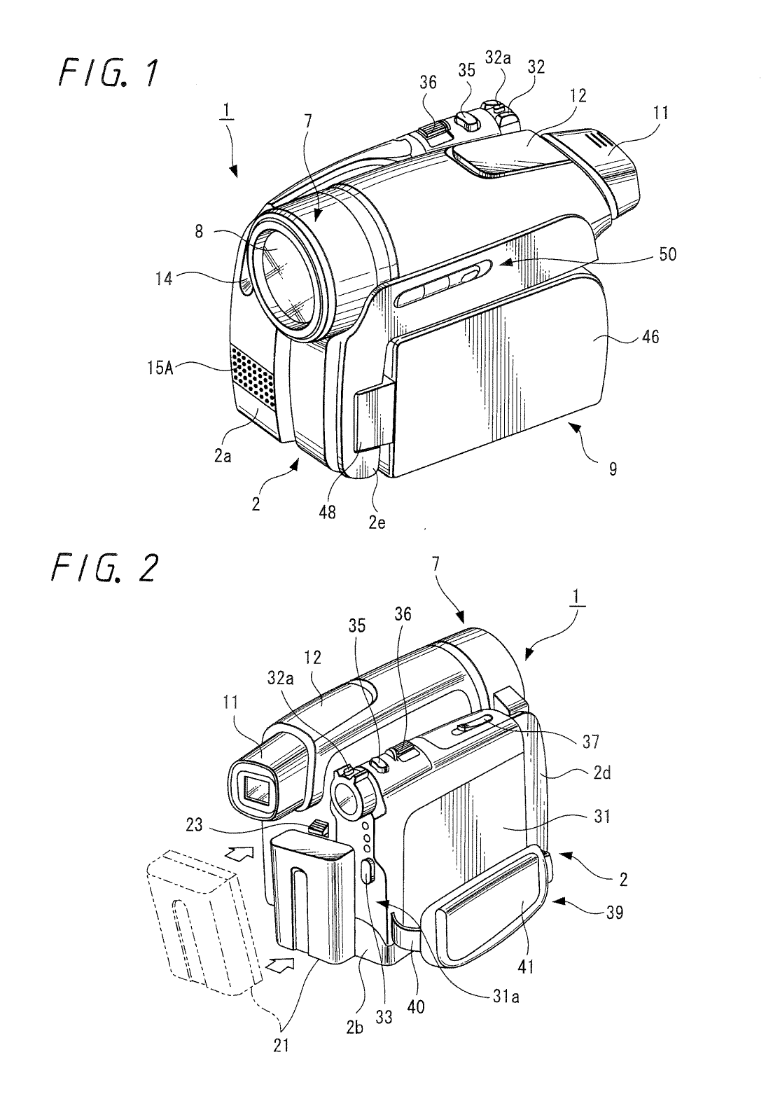

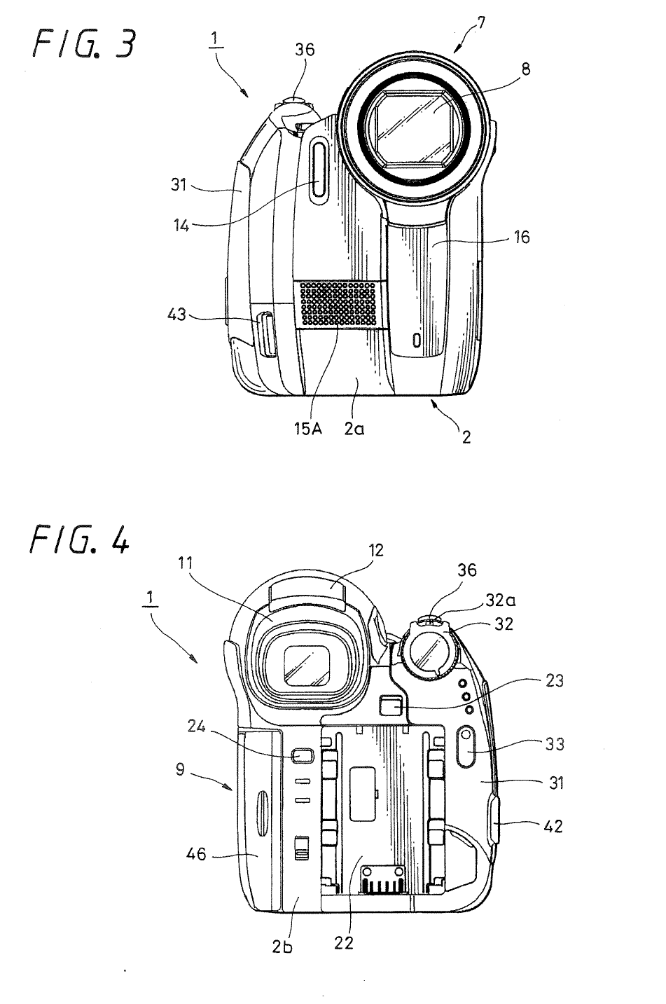

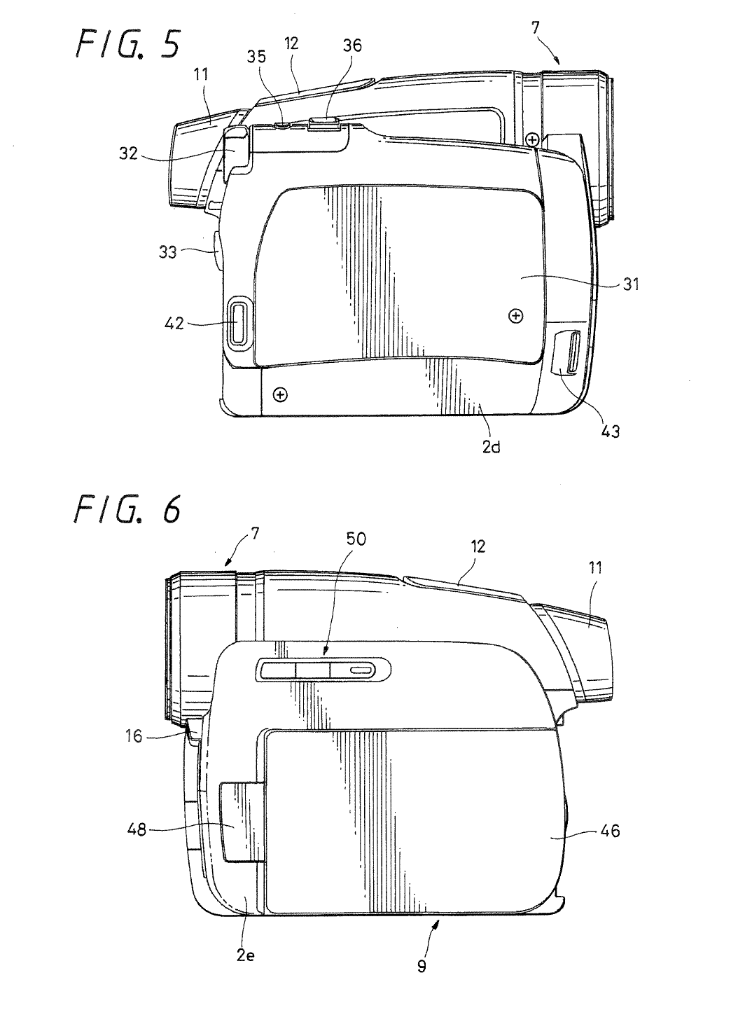

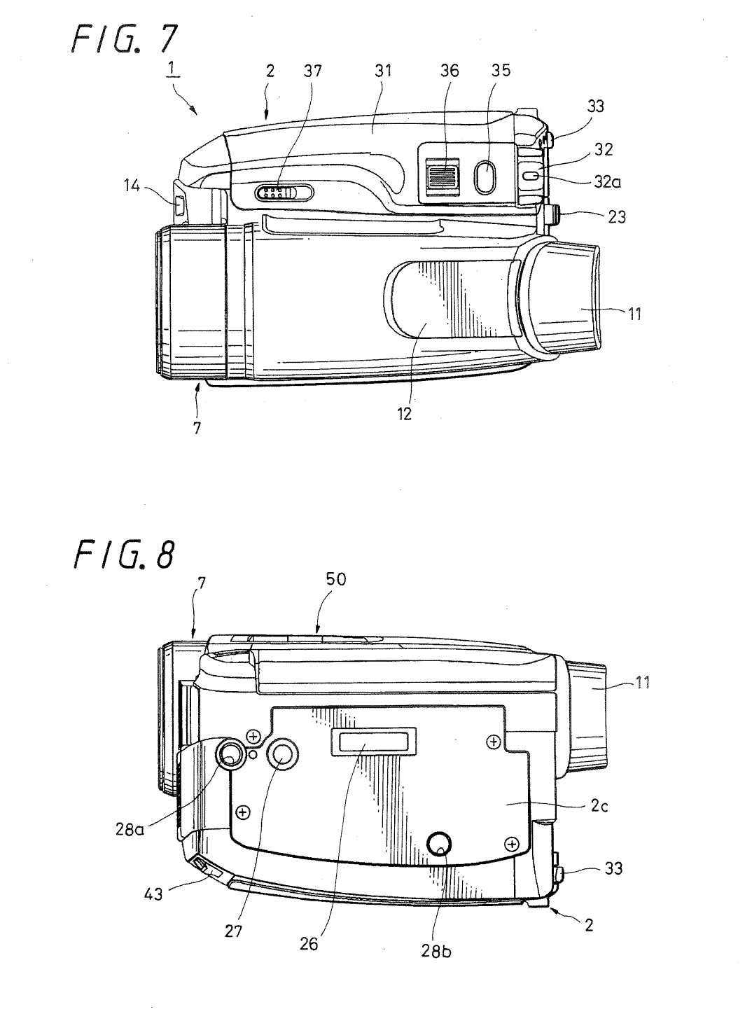

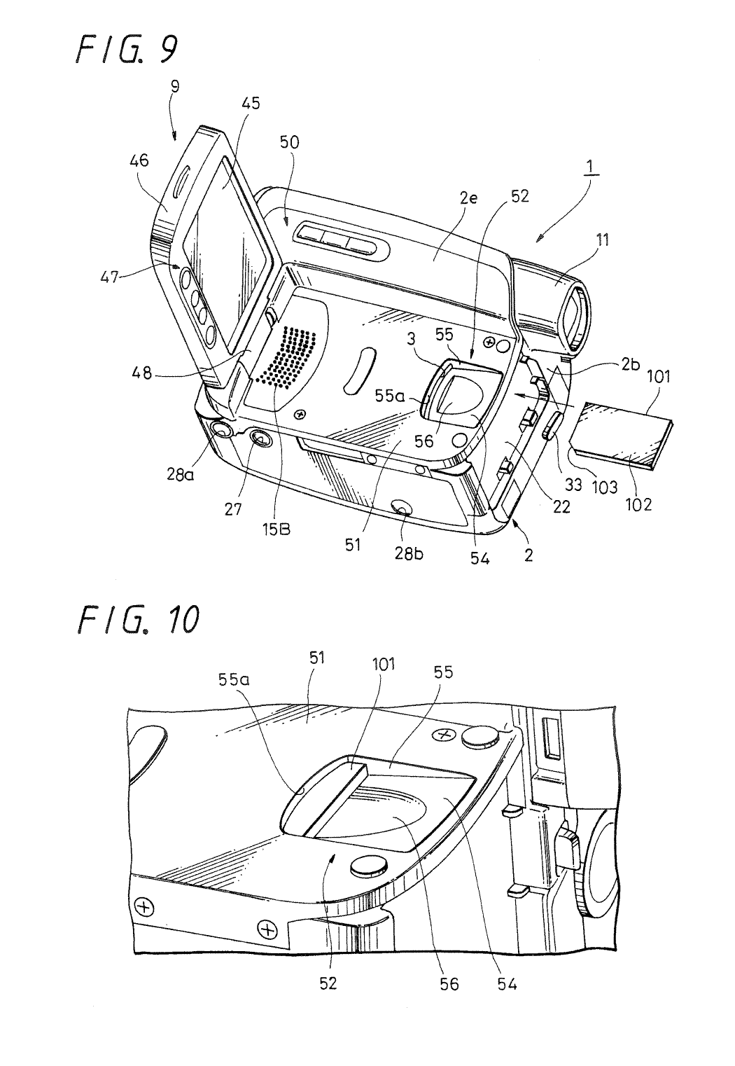

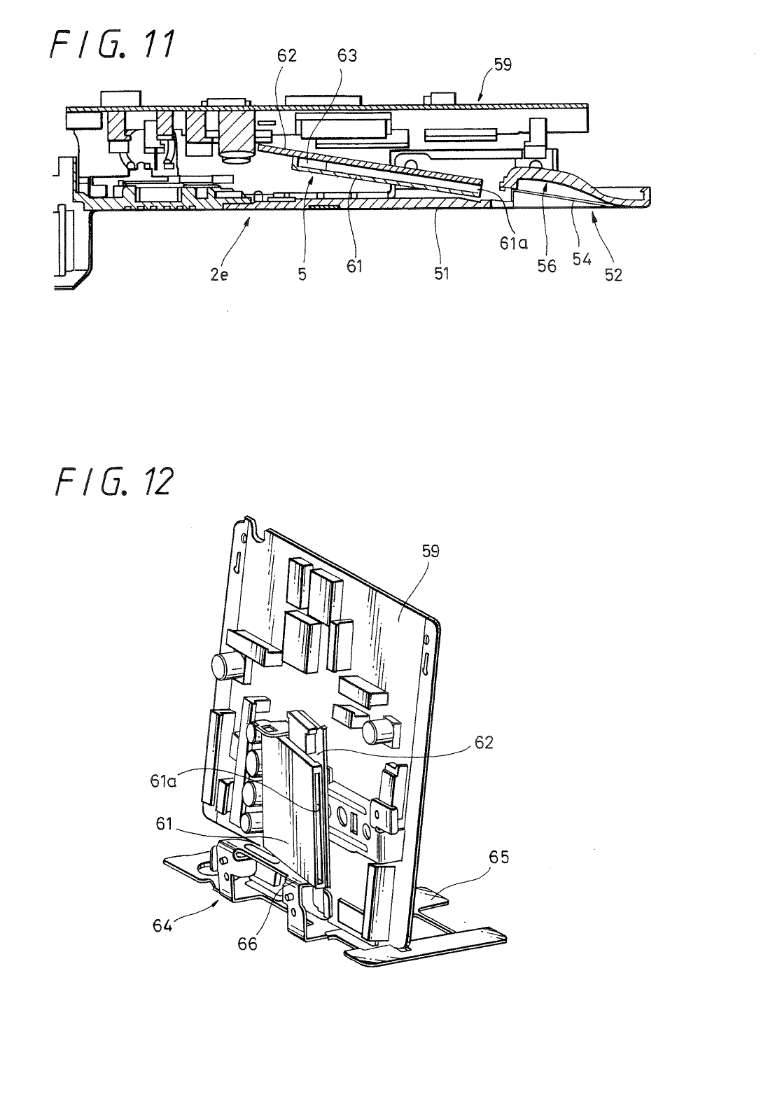

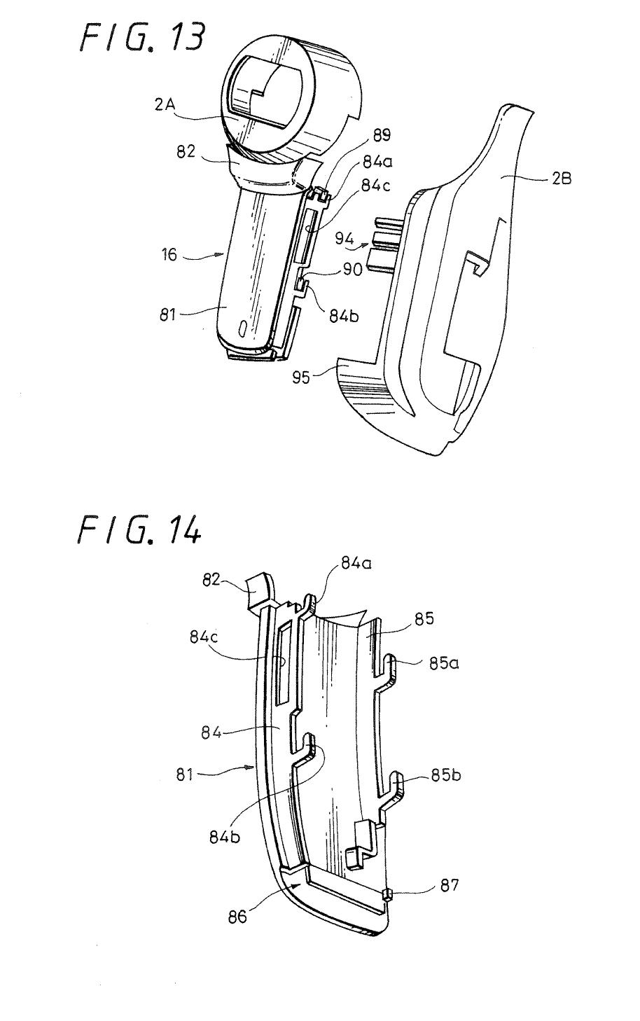

Hereinafter, an embodiment of the present invention is explained by referring to the attached drawings. FIGS. 1 through 16 are diagrams showing an imaging apparatus which is an example of an electronic apparatus according to an embodiment of the present invention. Specifically, FIG. 1 is a perspective view when viewing the imaging apparatus from a front side; FIG. 2 is a perspective view when viewing the imaging apparatus from a rear side; FIG. 3 is a front view; FIG. 4 is a rear view; FIG. 5 is a left side view; FIG. 6 is a right side view; FIG. 7 is a plan view; FIG. 8 is a bottom view; and FIG. 9 is a perspective view shown from a lateral side where a display unit is opened. Further, FIGS. 10 through 16 are diagrams showing relevant parts of the imaging apparatus shown in FIG. 1, in which FIG. 10 is an explanatory diagram showing a recording medium insertion slot in an enlarged manner; and FIG. 11 is an explanatory diagram showing cross-section of a recording medium storing portion. Further, FIG. 12 is an explanatory diagram showing an installed state of the recording medium storing portion; and FIGS. 13 through 16 are explanatory diagrams for explaining a face cover mounted on the imaging apparatus shown in FIG. 1.

An imaging apparatus 1 shown in FIGS. 1 through 9 is an electronic apparatus according to an embodiment of the present invention, in which two kinds of information recording media can be used. One of the two, which is mainly used, is a digital video cassette (hereinafter, referred to as “DV cassette”) using a tape-shaped recording medium as the information recording medium. The other is a semiconductor recording medium 101 showing a specific example of the information recording medium relating to an embodiment of the present invention, which is Memory Stick® produced by Sony Corporation, for example.

First, the semiconductor recording medium 101 showing a specific example of the information recording medium according to the embodiment of the present invention is explained. This semiconductor recording medium 101 is a card type recording medium where image data, voice data and the like can be recorded and reproduced. As shown in FIG. 9, the semiconductor recording medium 101 has a case 102 made of a flat casing formed into an approximately rectangular shape, and a memory having a large capacity is incorporated in the case 102. Plastic is suitable as a material of the case 102, for example.

A cut portion 103 to prevent an erroneous insertion is provided at a corner of the front end of the case 102, when inserting the case 102 into the electronic apparatus. Although not illustrated, a connector connected to a terminal on the apparatus body side when mounting the semiconductor recording medium 101 on the electronic apparatus is exposed on the rear side of the case 102.

In the imaging apparatus 1 (hereinafter, referred to as “digital video camera”), optical images are converted into electric signals by CCD (Charge Coupled Device) to be selectively recorded in the DV cassette that is a first external memory unit and in the semiconductor recording medium 101 that is a second external memory unit, and to be displayed on a display unit such as a liquid crystal monitor, as shown in FIGS. 1 through 9. The digital video camera 1 is configured to have a hollow external case 2, a recording medium insertion slot 3, a recording medium storing portion 5, a lens unit 7, a display unit 9, a mechanical deck (not illustrated), and the like. The hollow external case 2 is made of a horizontal long casing. The recording medium insertion slot 3 is provided in a lateral surface on one side of the external case 2. The semiconductor recording medium 101 is detachably inserted through the recording medium insertion slot 3 of the recording medium storing portion 5. The lens unit 7 includes an objective lens 8 disposed in the front of the external case 2. The display unit 9 also functions as a finder and a touch operation panel. The DV cassette is detachably mounted in the mechanical deck.

The external case 2 includes: a front surface portion 2a where the objective lens 8 is exposed, a rear surface portion 2b forming a rear surface, a bottom surface portion 2c forming a bottom surface, a left side surface portion 2d forming a side surface on the left side viewed from the front, and a right side surface portion 2e forming a side surface on the right side. The lens unit 7 is incorporated in an upper part of the external case 2 to be fixed thereto. Although not illustrated, the CCD is arranged behind the lens unit 7 in the external case 2, and a viewfinder 11 is arranged behind the CCD. Furthermore, an accessory shoe (not illustrated) where accessories such as a lighting unit and external microphone are detachably mounted is provided in an upper part of the external case. The accessory shoe is arranged immediately before the viewfinder 11 and is usually covered with a shoe cap 12 constituting a lid to fill the space while being not used.

As shown in FIG. 3 and other figures, a flash unit 14 disposed on the left side of the objective lens 8 and a first built-in microphone 15A disposed below the flush unit 14 are provided in the front surface portion 2a of the external case 2. Further, a face cover 16 is detachably mounted on a lower side of the objective lens 8 in the front surface portion 2a. The face cover 16 is used mainly in view of design and is mounted when assembling the external case 2 formed of a plurality of members.

As shown in FIG. 13, the front surface portion 2a of the external case 2 is formed of a front side case member 2A where the objective lens 8 is stored and a right side case member 2B constituting the right side of the external case 2 when viewed from the front. In addition, the face cover 16 is mounted to be held between the front side case member 2A and the right side case member 2B. The face cover 16 includes a plate 81 constituting an approximately rectangular board and a step portion 82 continuous with an end of the plate 81 in the lengthwise direction. The step portion 82 of the face cover 16 is projected approximately vertically from a front side of the plate 81, and the end thereof is formed into a circular arc shape corresponding to a cylindrical portion of the front side case member 2A where the objective lens 8 is stored.

As shown in FIG. 14, a first projected strip section 84 and a second projected strip section 85 are provided on the rear side of the plate 81 on both sides in the lengthwise direction. On the upper surface of the first projected strip section 84 are provided a first engagement claw 84a, a second engagement claw 84b, and a rectangular through hole 84c that penetrates the front and rear surfaces facing the second projected strip section 85. The first and second engagement claws 84a and 84b of the first projected strip section 84 are engaged with later-described engagement projection portions 89 and 90 provided in the front side case member 2A. Further, a projected section 94 of the right side case member 2B is inserted through the rectangular through hole 84c.

The second projected strip section 85 is formed into an elongated projected strip having the shape similar to the first projected strip section 84, and a first engagement claw 85a and a second engagement claw 85b are provided on the upper surface thereof. Those engagement claws 85a and 85b are engaged with later-described engagement holes 91 and 91 of the front side case member 2A. Further, an engagement groove 86 engaged with a lateral section 95 of the right side case member 2B and an engagement projection 87 engaged with a later-described earth member 92 of the front side case member 2A are provided at the end portion on the opposite side to the step portion on the rear side of the plate 81. Such face cover 16 is formed of metal material such as aluminum alloy, metal-plated synthetic resin, and the like in view of design.

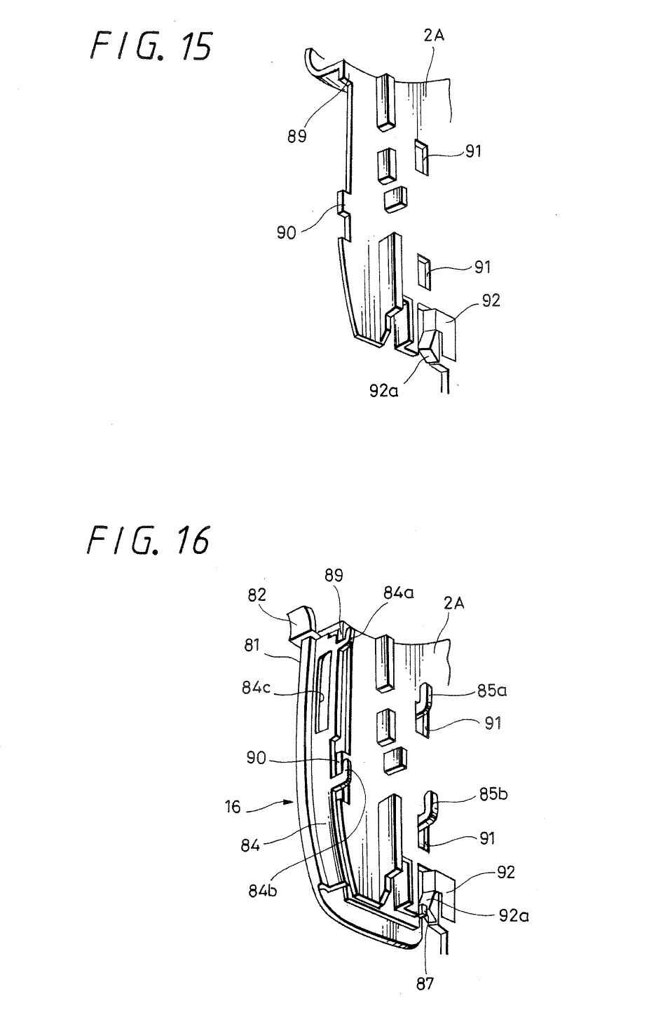

As shown in FIG. 15, two cut portions are provided in the front side case member 2A along one side corresponding to the face cover 16, and the engagement projection portions 89 and 90 are formed accordingly. In addition, the engagement holes 91 and 91 are provided in the front side case member 2A at positions corresponding to the first and second engagement claws 85a and 85b that are provided on the second projected strip section 85 of the face cover 16. Further, the earth member 92 formed of a metal material is attached to the lower end portion of the front side case member 2A as shown in FIG. 15. The earth member 92 has a bent spring portion 92a having a U-shaped plane, and the engagement projection 87 of the face cover 16 is engaged with the spring portion 92a.

The above-described face cover 16 can be mounted without difficulty on the external case 2 in the following manner, for example. First, the face cover 16 is engaged with the front side case member 2A. Specifically, the engagement claws 84a and 84b provided in the first projected strip section 84 of the face cover 16 are engaged with the respective engagement projection portions 89 and 90 of the front side case member 2A and the engagement claws 85a and 85b provided in the second projected strip section 85 of the face cover 16 are engaged with the engagement holes 91 and 91 of the front side case member 2A as shown in FIG. 16.

At this time, the engagement projection 87 of the face cover 16 engages with the spring portion 92a of the earth member 92 attached to the front side case member 2A. Hence, the engagement projection 87 and the spring portion 92a come in contact with each other and therefore a contact portion thereof can be a contact point of the earth. Further, since the face cover 16 is biased in a lateral direction (direction toward the left side in FIG. 16) by spring force of the spring portion 92a, the face cover 16 can be temporarily fixed to the front side case member 2A.

Next, the right side case member 2B is engaged with an assembled body in which the face cover 16 is engaged with and temporarily fixed to the front side case member 2A. Specifically, the projecting section 94 of the right side case member 2B is inserted through the rectangular through hole 84c provided in the first projected strip section 84 of the face cover 16 and the lateral section 95 of the right side case member 2B is engaged with the engagement groove 86 of the face cover 16. Thus, the face cover 16 is mounted on the external case 2. Being engaged with the front side case member 2A and right side case member 2B to be mounted, the face cover 16 can easily be mounted on and detached from the external case 2, and there is no need to use a fastening mechanism such as a fixing screw and adhesive, thereby reducing costs.

As shown in FIG. 4 and other figures, a battery storing portion 22 where a power supply battery 21 is mounted in a detachable manner, a battery lock release button 23 disposed above the battery storing portion 22, and a flush switch 24 to turn ON/OFF the flush unit 14 are provided in the rear surface portion 2b of the external case 2. The battery storing portion 22 is opened to have a size approximately the same as the surface of the power supply battery 21 mounted. The power supply battery 21 is inserted obliquely downward to be mounted and is capable of being detached in that direction by pushing the battery lock release button 23.

As shown in FIG. 8, in the bottom surface portion 2c of the external case 2 are provided a connection terminal 26 connected to a cradle unit (not illustrated) and the like; a tripod screw hole 27; and two positioning holes 28a and 28b for determining the position when attaching the digital video camera 1 to the cradle unit, the tripod and the like. The connection terminal 26 is disposed in approximately the center in the width direction of the bottom surface portion 2c, and the connection terminal 26 is connected to a connector of the cradle unit. With this, electric video/audio signals and the like can be transmitted and received between the digital video camera 1 and an external device such as a personal computer and television set, and the power supply battery 21 mounted in the battery storing portion 22 can be charged, through the cradle unit, for example.

As shown in FIGS. 2, 5 and other figures, an opening portion to expose an upper surface and side surface of the mechanical deck is provided in the left side surface portion 2d of the external case 2, and the opening portion can be opened and closed by a mechanical deck lid 31. Although not illustrated, the mechanical deck is fixed inside the external case 2 and is configured to have a cassette holder in which the DV cassette is detachably mounted; a rotating head drum with a magnetic head; a control unit which controls the rotating head drum to be driven, for example, and so on.

The mechanical deck lid 31 is turnably joined to a lower part of the left side surface portion 2d by using a joining mechanism such as a hinge. Turning operation of the mechanical deck lid 31 is synchronized with operation of the cassette holder of the mechanical deck. Upon opening the mechanical deck lid 31 to open the above-mentioned opening portion, a DV cassette insertion slot of the cassette holder in the mechanical deck is opened. Accordingly, the DV cassette can be mounted on the cassette holder and a tape cassette mounted on the cassette holder in advance can be removed.

A lateral portion 31a of the mechanical deck lid 31 is provided to form the same plane as the rear surface portion 2b of the external case 2 in the state in which the mechanical deck lid 31 is closed. A power/mode switching dial 32 is provided on the right side of the viewfinder 11 in the lateral portion 31a of the mechanical deck lid 31, and a recording button 33 is provided under the power/mode switching dial 32. The recording button 33 is made of a push-push switch mechanism, and capturing moving image is started and stopped by repeatedly pushing the recording button 33 A lock release button 32a is provided on an upper part of the power/mode switching dial 32, and power ON/OFF is switched by turning the power/mode switching dial 32 after pushing the lock release button 32a. Further, at a power-on position the power/mode switching dial 32 is capable of being turned in the direction opposite to a power-off position and the dial returns to the power-on position after such turning operation. Thus, three modes of “tape record mode” of recording images on the DV cassette, “memory record mode” of recording images on the semiconductor recording medium 101, and “view/edit mode” are executed sequentially by repeating the turning operation, and an arbitrary mode can be selected among the three modes.

Further, a shutter button 35, a zoom lever 36, a lid lock release button 37 are provided on an upper part of the mechanical deck lid 31 in this order from the side of lateral portion 31a. The shutter button 35 is used to capture still images, and one still image is captured by pushing this button once. The zoom lever 36 is used to magnify or reduce an image during capturing, and the magnification or reduction of the image is continuously performed within a predetermined range according to the amount of operation of this lever. The lid lock release button 37 is used to release the closed and locked state of the mechanical deck 31, and a turning operation of the mechanical deck lid 31 can be performed by sliding the button.

Further, as shown in FIG. 2, a hand strap 39 is attached to the left side surface portion 2d of the external case 2, surrounding the mechanical deck lid 31. The hand strap 39 is provided for supporting user's operation, by tightly contacting with a back of a user's hand that grips the digital video camera 1, so as not to drop the camera. The hand strap 39 includes a support belt 40 and a protection pad 41 attached to the support belt 40 in contact with the back of the user's hand. One end of the support belt 40 is fixed to a first belt-attaching portion 42 provided in a lower part on the rear side of the mechanical deck lid 31, and the other end is fixed to a second belt-attaching portion 43 provided in a lower part on the front side of the left side surface portion 2d of the external case 2.

As shown in FIGS. 1, 9 and other figures, the display unit 9 showing a specific example of an opening and closing member is attached to the right side surface 2e of the external case 2 in a manner capable of changing a posture thereof. The display unit 9 includes a flat panel monitor 45, a monitor case 46, a monitor side operation portion 47, a case support portion 48, and the like. The flat panel monitor 45 is a planar monitor such as a liquid crystal display. The monitor case 46 stores the flat panel monitor 45. The monitor side operation portion 47 includes a plurality of operation buttons disposed on a surface of the monitor case 46 on the side where the flat panel monitor 45 is exposed. The case support portion 48 supports the monitor case 46 with respect to the external case 2 in a manner capable of changing a posture thereof. The case support portion 48 has a horizontal turning function causing the monitor case 46 to turn in the horizontal direction by approximately 90° with a vertical axis being the center of the turning movement and an anterior-posterior turning function causing the monitor case 46 to turn in the anterior-posterior direction by approximately 180° with a horizontal axis being the center of the turning movement.

As a result, the display unit 9 can arbitrarily be brought into a state where, as shown in FIG. 1, the flat panel monitor 45 is closed facing the right side surface portion 2e of the external case 2; a state where, as shown in FIG. 9, the flat panel monitor 45 faces backward by turning the monitor case 46 in the horizontal direction by approximately 90° from the above state; and a state of any position between the two states. Furthermore, the display unit 9 can also arbitrarily be brought into a state where the flat panel monitor 45 faces forward by turning the monitor case 46 in the anterior-posterior direction by 180° from the state shown in FIG. 9; a state where the monitor case 46 is closed with the flat panel monitor 45 facing outside by turning the monitor case 46 in the horizontal direction by approximately 90° toward the external case 2 from the above state; and a state of any position between the two states.

Further, in the right side surface portion 2e of the external case 2 is provided an outside operation portion 50 including a plurality of operation buttons disposed above the display unit 9 in a state of the display unit 9 being closed. For example, a backlight button to turn ON/OFF a backlight disposed on the rear surface of the flat panel monitor 45, an information button used for displaying a remaining amount of the power supply battery 21, remaining time available for capturing images and the like on the flat panel monitor 45, a menu button, and the like can be listed as the operation buttons.

As shown in FIG. 9, the recording medium insertion slot 3 to store the semiconductor recording medium 101 in the recording medium storing portion 5 disposed inside the external case 2, and a second built-in microphone 15B are provided in an opening and closing surface 51 of the right side surface portion 2e covered with the display unit 9 capable of being open and closed. The recording medium insertion slot 3 is disposed in a concave portion 52 provided in the rear middle part of the right side surface portion 2e, and the second built-in microphone 15B is disposed in the front middle part that is the opposite side to the concave portion 52.

The concave portion 52, where the recording medium insertion slot 3 is disposed, functions as a guide portion to lead the movement of the semiconductor recording medium 101 when the semiconductor recording medium 101 is inserted into or removed from the recording medium storing portion 5 provided inside the external case 2. The concave portion 52 has an approximately quadrangular plane, and the length of two sides opposed to each other and extending in the upper-lower direction of the external case 2 is set approximately equal to the length in the widthwise direction of the semiconductor recording medium 101.

As shown in FIG. 10, the concave portion 52 is formed of: a bottom surface 54 gradually inclined from the vicinity of the rear end of the opening and closing surface 51 toward the inside of the external case 2, and walls 55 continuing from three sides of the bottom surface 54 and rising up to the opening and closing surface 51. Further, among the walls 55 of the concave portion 52, the recording medium insertion slot 3 is disposed in an end surface 55a facing the back and is opened continuously from the bottom surface 54.

A recess 56 is provided in the bottom surface 54 of the concave portion 52 to facilitate the operation of mounting/removing the semiconductor recording medium 101 stored in the recording medium storing portion 5. The recess 56 has an approximately semicircle plane, and is made into a slope gradually being upward from a straight line portion to a circular arc portion. Also, the height of the end surface 55a of the concave portion 55 is set larger than the thickness of the semiconductor recording medium 101. As a result, the rear end of the semiconductor recording medium 101 exposed from the recording medium insertion slot 3 is not projected from the opening and closing surface 51 of the external case 2 in the state of the front end of the semiconductor recording medium 101 in the insertion direction being stored in the recording medium storing portion 5, and therefore there is no fear of interfering with the display unit 9.

FIGS. 11 and 12 are diagrams showing an installed state of the recording medium storing portion 5 disposed inside the external case 2. FIG. 11 is an explanatory diagram showing the cross-section of the external case 2 in the horizontal direction, and FIG. 12 is an explanatory diagram showing the recording medium storing portion 5 and other portions inside the external case 2. As shown in FIG. 11, a control circuit substrate 59 on which various electronic components are mounted is disposed on the side of the right side surface portion 2e inside the external case 2, and the recording medium storing portion 5 is disposed in a space between the control circuit substrate 59 and the right side surface portion 2e.

As shown in FIG. 12, the recording medium storing portion 5 includes a hollow storing portion body 61 made of an approximately quadrangular flat case, a recording medium substrate 62 integrally attached to one plane of the storing portion body 61, and the like. In the storing portion body 61, an opening portion (not illustrated) is provided in a plane where the recording medium substrate 62 is attached and an opening portion 61a from which the semiconductor recording medium 101 is inserted and removed is provided in one of four side surfaces orthogonal to the plane where the opening portion is provided.

A push-push mechanism (pushing operation mechanism) 63, which is not illustrated, is provided in the storing portion body 61, and mounting and removing of the semiconductor recording medium 101 are alternately executed by repeatedly pushing the semiconductor recording medium 101 stored. In addition, a connector terminal inserted through the opening portion on the side of the recording medium substrate 62 of the storing portion body 61 is mounted on the recording medium substrate 62 although not illustrated. This connector terminal is connected to the connector of the semiconductor recording medium 101 in the state of the semiconductor recording medium 101 being mounted in the storing portion body 61.

Such recording medium storing portion 5 as described above is attached to a support member 64. The support member 64 includes a support stand portion 65 fixed to the inside of the external case 2, a holding portion 66 formed by bending one end of the support stand portion 65, and the like. Here, the recording medium storing portion 5 is attached to the holding portion 66, and the plane of the storing portion body 61 is fixed in a posture inclined in parallel with the bottom surface 54 of the concave portion 52 provided in the right side surface portion 2e. As a result, a posture of the recording medium storing portion 5 becomes such inclined posture that the opening portion 61a of the storing portion body 61 is opposed to the recording medium insertion slot 3 in the opening and closing surface 51 of the right side surface portion 2e and the semiconductor recording medium 101 inserted from the recording medium insertion slot 3 is stored obliquely with respect to the opening and closing surface 51.

According to the digital video camera 1 having such configuration, the semiconductor recording medium 101 can be stored and mounted in the recording medium storing portion 5 in the following manner, for example. First, the semiconductor recording medium 101 is inserted from the recording medium insertion slot 3 provided in the opening and closing surface 51 of the right side surface portion 2e, and the front end in the insertion direction of the semiconductor recording medium 101 is inserted into the recording medium storing portion 5. At this time, since the semiconductor recording medium 101 is moved along the bottom surface 54 of the concave portion 52 where the recording medium insertion slot 3 is provided, the semiconductor recording medium 101 can be easily inserted into the recording medium insertion slot 3.

Next, the semiconductor recording medium 101 is pushed in the insertion direction. Accordingly, the semiconductor recording medium 101 is mounted in the recording medium storing portion 5 by the push-push mechanism 63 provided in the recording medium storing portion 5. At this time, the fingertip can deeply be inserted into the recess 56 provided in the bottom surface 54 of the concave portion 52, and therefore force can securely be applied by placing the center of the fingertip at the end portion of the semiconductor recording medium 101 and the pushing operation of the semiconductor recording medium 101 can easily be performed. In addition, since the rear end in the insertion direction of the semiconductor recording medium 101 exposed from the recording medium insertion slot 3 is positioned inside the concave portion 52, the rear end is not projected from the opening and closing surface 51 of the external case 2 and there is no possibility of damaging the flat panel monitor 45, without contacting the flat panel monitor 45 being faced when the display unit 4 is closed.

Also, in the case where the semiconductor recording medium 101 is removed from the recording medium storing portion 5, the semiconductor recording medium 101 is pushed again toward the insertion direction. Accordingly, the mounted semiconductor recording medium 101 is released by the push-push mechanism 63 provided in the recording medium storing portion 5 and is slightly pushed back in the direction of removing thereof. Further, the semiconductor recording medium 101 can be removed from the recording medium storing portion 5 by pulling the semiconductor recording medium 101 along the bottom surface 54 of the concave portion 52.

Subsequently, the display unit 9 is closed. Hence, the display unit 9 serves as the lid to close the recording medium insertion slot 3. As a result, dust and dirt can be prevented from entering the inside of the external case 2 from the recording medium insertion slot 3. In addition, the recording medium insertion slot 3 can be prevented from appearing on the surface of the apparatus body, and so design can be improved.

As described above, in the electronic apparatus according to an embodiment of the present invention, the recording medium storing portion is obliquely provided so that the information recording medium is obliquely stored with respect to one surface of the apparatus body, where the recording medium insertion slot is provided. Therefore, the limited space extended in parallel with one surface of the apparatus body, where the recording medium insertion slot is provided, can be efficiently used, thereby the apparatus body being small-sized and thin.

Further, the opening and closing member turnably supported on the apparatus body is provided and the recording medium insertion slot is provided in one surface of the apparatus body closed by this opening and closing member. Therefore, the recording medium insertion slot can be covered by closing the opening and closing member so that the dirt and dust can be prevented from entering the apparatus body from the recording medium insertion slot when carrying and storing the electronic apparatus, for example. Moreover, since there is no need to particularly provide a lid to the recording medium insertion slot, the number of parts can be reduced and the number of work processes can be reduced, thereby reducing costs.

Furthermore, since the recording medium insertion slot is disposed in the concave portion provided in one surface of the apparatus body and the concave portion provided with the inclined surface serves as the guide when inserting and removing the information recording medium, the information recording medium can easily be inserted and removed. Further, since the push-push mechanism is provided in the recording medium storing portion, the information recording medium can easily be mounted and dismounted in the recording medium storing portion only by pushing the information recording medium. Moreover, since the concave portion includes the recess provided in the inclined surface thereof, force can securely be applied to the end portion of the information recording medium with deeply inserting the fingertip into the recess 56, and so the information recording medium can easily be pressed.

According to the embodiment of the present invention, the electronic apparatus is configured to have the recording medium insertion slot that is disposed in the side surface of the apparatus body, however, not limited thereto, the recording medium insertion slot according to the embodiment of the present invention may be disposed in the upper surface, front surface and the like of the apparatus body. In such case, it is more suitable if there is provided a lid such as the display unit 9.

An embodiment of the present invention is not limited to the embodiment described above and shown in the drawings, but various alterations and modifications can be made without departing from the scope and spirit of the present invention. For example, an example of the application to the digital video camera is explained as the imaging apparatus according to the above-described embodiment, but an embodiment of the present invention can also be applied to a digital still camera, a mobile phone unit, a portable game device, and various kinds of other electronic apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic apparatus comprising:
an apparatus body having on one surface thereof a recording medium insertion slot of a recording medium storing portion where an information recording medium is detachably stored, wherein
said recording medium storing portion is obliquely provided such that said information recording medium is obliquely stored with respect to said one surface of said apparatus body.

2. An electronic apparatus according to claim 1, wherein:
said apparatus body has an opening and closing member turnably supported by a turning mechanism; and
said recording medium insertion slot is disposed at a position closed with said opening and closing member of said apparatus body.

3. An electronic apparatus according to claim 1, wherein
said apparatus body has said recording medium insertion slot provided on an end surface of a concave portion provided in one surface of the apparatus body, and a bottom of the end surface is continuous with said one surface with an inclining surface to be a guide when inserting said recording medium into said recording medium storing portion.

4. An electronic apparatus according to claim 1, wherein
a push-push mechanism, with which mounting operation and removing operation of the information recording medium are alternately executed by repeatedly pressing said information recording medium, is provided in said recording medium storing portion.

5. An electronic apparatus according to claim 3, wherein
a recess for facilitating said pressing operation on said information recording medium is provided in said inclined surface.
